(19) United States
(12) Patent Application Publication
(10) Pub. No.: US 2006/0215749 A1
(43) Pub. Date: Sep. 28, 2006

(54) WAVEFORM DISPLAY DEVICE

(75) Inventors: Genichi Imamura, Yokohama-shi, Kanagawa (JP); Hiroyuki Tomita, Yokohama-shi, Kanagawa (JP); Koji Yano, Yokohama-shi, Kanagawa (JP)

Correspondence Address: FISH & RICHARDSON P.C., P.O. BOX 1022, MINNEAPOLIS, MN, 55440-1022, US

(73) Assignee: Leader Electronics Corporation, Yokohama-shi (JP)

(21) Appl. No.: 11/277,589

(22) Filed: Mar. 27, 2006

(30) Foreign Application Priority Data
Mar. 28, 2005 (JP) 2005-091000

(51) Int. Cl. H04N 11/04; H04N 11/02; H04N 7/12; H04B 1/66

(52) U.S. Cl. 375/240.01

(57) ABSTRACT

A waveform monitor comprises: means (51) for converting a compressed video signal into uncompressed parallel data; means (33) for converting the parallel data into waveform display data; means (52) for analyzing a transmission status of the compressed video signal and generating analysis data; and means (36) for displaying the waveform display data and the analysis data simultaneously. The waveform monitor can further comprise: means (31) for converting an SDI signal into parallel data; and means (32) for analyzing a transmission status of the SDI signal and generating the analysis data.

### BACKGROUND OF THE INVENTION

The present invention relates to a device for displaying a waveform of a video signal, more specifically, to a device for displaying a waveform of a compressed video signal and analyzing a transmission status of the compressed video signal.

FIG. 1 is a view for schematically explaining a flow of a video signal, for example, in a broadcasting station. As shown in FIG. 1, in a broadcasting station A, an MPEG-TS (transport stream) signal flows from, a TS output device 11 to a digital modulator 12; a TS signal digital modulated, for example, to an ISDB-T (integrated services digital broadcasting-terrestrial transmission) format flows from the digital modulator 12 to an up converter 13; and the TS signal further converted into a first predetermined frequency is transmitted from the broadcasting station A. Note that a device for outputting a DV (digital video) stream can be used instead of the TS output device 11, and in this case, the DV stream signal is transmitted from the broadcasting station A in place of the TS signal. Although, a case of a TS signal will be hereinafter described, a signal compressed in another formats, such as a DV stream signal, may be used in place of the TS signal.

In a broadcasting station B, the transmitted TS signal is converted into a second predetermined frequency by a down converter 21, and this signal is further demodulated to a TS signal by a digital demodulator 22. The TS signal output from the digital demodulator 22 is input into an analyzer 23, where a transmission status thereof is analyzed.

The analyzer 23 can analyze a transmission status of an video signal compressed in MEG format, represented by a TS signal, and display an analysis result thereof. Such an analyzer 23 is disclosed, for example, in U.S. Pat. Nos. 5,774,497 and 6,650,719; Hoei Sangyo CO., LTD “DVStation (Products),”, internet <URL: http://www.hoei.co.jp/japan/product/pixelmetrix/dvstation.h tml>; and Tektronix, Inc. “MPEG Test System (Products),” internet <URL: http://www.tek.com/site/ps/0,,2A-14844-INTRO_EN,00.html>. However, the analyzer 23 cannot display the waveform of the video signal. Therefore, a user has not been able to monitor a waveform of the video signal by using the analyzer 23. Conventionally, in these circumstances the user has been required to further provide a decoder 24 and a waveform monitor 25.

The TS signal output from the digital demodulator 22 is also input into the decoder 24, and an SDI (serial digital interface) signal converted from the TS signal flows from the decoder 24 to the waveform monitor 25. Meanwhile, such a decoder 24 is disclosed in, for example, NTT Electronics Corporation, “HDTV Decoder HD1000 (Products),” internet <URL: http://www.nel-world.com/products/systems/hdtv_en_de.html>; and such a waveform monitor 25 is disclosed in, for example, Leader Electronics Corp., “LV, 5750 (Products),” internet <URL: http://www.leader.co.jp/english/product/lv_{—}5750_e.html>.

FIG. 2 is a schematic functional block diagram of the waveform monitor 25. As shown in FIG. 2, the SDI signal is converted into parallel data by a converter 31, and the parallel data is converted into waveform display data by a generator 33. The parallel data may be converted into vectorscope display data and/or video display data by the generator 33. The display data generated by the generator 33 (for example, the waveform display data, the vectorscope display data, and the video display data) flows to an image generator 35, and the user can monitor the data displayed on a display 36.

As shown in FIG. 2, the SDI signal is also converted into analysis data by an of analyzer 32; the analysis data is converted into analysis display data by a generator 34; and the analysis display data flows to the image generator 35.

The image generator 35 combines the display data generated by the generator 33 (for example, the waveform display data, the vectorscope display data and the video display data) generated by the generator 33 and the analysis display data generated by the generator 34 to generate one image (frame) data, and outputs it to the display 36. The display 36 displays the one image (frame) data. Thereby, the user can monitor the display data generated by the generator 33 (for example, the waveform display data, the vectorscope display data and the video display data) and the analysis display data generated by the generator 34.

FIG. 3 is a view showing an example of displaying the waveform display data, the vectorscope display data and the video display data generated by the generator 33, and the analysis display data generated by the generator 34.

### SUMMARY OF THE INVENTION

Conventionally, in order to monitor a transmission status and a waveform status of a compressed transmission signal (a Ts signal, a DV stream signal, or the like), a user has been required to provide an analyzer, a decoder and a waveform monitor. Therefore, the user has been required to operate each of the analyzer, the decoder and the waveform monitor. And the user has been required to monitor a display of each of the analyzer and the waveform monitor.

An object of the present invention is to provide a waveform monitor in which the user easily monitors the transmission status and the waveform status of the compressed transmission signal.

Other objects of the present invention will be apparent for one skilled in the art, by referring to the claims, the embodiments of the invention to be described hereinafter, and the drawings.

A waveform monitor according to the present invention includes: means (51) for converting a compressed video signal into uncompressed parallel data; means (33) for converting the parallel data into waveform display data; means (52) for analyzing a transmission status of the compressed video signal and generating analysis data; and means (36) for displaying the waveform display data and the analysis data simultaneously. Thew monitor may further include: means (31) for converting a SDI signal into parallel data; and means (32) for analyzing a transmission status of the SDI signal and generating analysis data.

The means (33) for converting the parallel data into the waveform, display data may input the uncompressed parallel data from the compressed video signal and the parallel data from the SDI signal. And the means (33) for converting the parallel data into the waveform display data can select the parallel data from the SDI signal. Or, the means (33) for converting the parallel data into the waveform display data can select the uncompressed parallel data from the compressed video signal. The means (33) for converting the parallel data into the waveform display data nay convert a selected parallel data into the waveform display data.

It is preferable that the means (33) for converting the parallel data into the waveform display data also converts the parallel data into vectorscope display data and video display data; and the means (36) for displaying the waveform display data and the analysis data simultaneously also displays the vectorscope display data and the video display data.

The means (51) for converting the compressed video signal into the uncompressed parallel data may convert a compressed sound signal into uncompressed second parallel data, and the waveform monitor may further includes means (81) for converting the second parallel data into sound signal information data. The means (36) for displaying the waveform display data and the analysis data simultaneously can display the waveform display data and the sound signal information data simultaneously, and herein, the means (36) may or not display the analysis data simultaneously.

And, the compressed video signal is preferably a video signal compressed in TS signal format or in DV stream format.

In a waveform monitor according to the present invention, a compressed transmission signal (a TS signal, a DV stream signal, or the like) is converted not into a SDI signal but parallel data, and afterward, converted into a waveform display data. And in the waveform monitor, a transmission status of the compressed transmission signal is analyzed. Therefore, a user can monitor the transmission status and the waveform status of the compressed transmission signal by using one waveform monitor. As a result, the user is required to monitor only one display of the waveform monitor, and therefore, the user can easily monitor the transmission status and the waveform status of the compressed transmission signal.

Furthermore, since it is not necessary to convert a compressed transmission signal into a SDI signal, costs are reduced. In other words, it is not necessary to convert the parallel data, obtained by converting the compressed transmission signal, into serial data, and convert the serial data into the SDI format. Other advantages will be apparent for a person skilled in the art, by referring to the claims, the embodiments of the invention to be described hereinafter, and drawings.

### BRIEF DESCRIPTION OF THE DRAWINGS

FIG. 1 is a view for schematically explaining a flow of a video signal, for example, in a broadcasting station;

FIG. 2 is a functional block diagram of a waveform monitor 25;

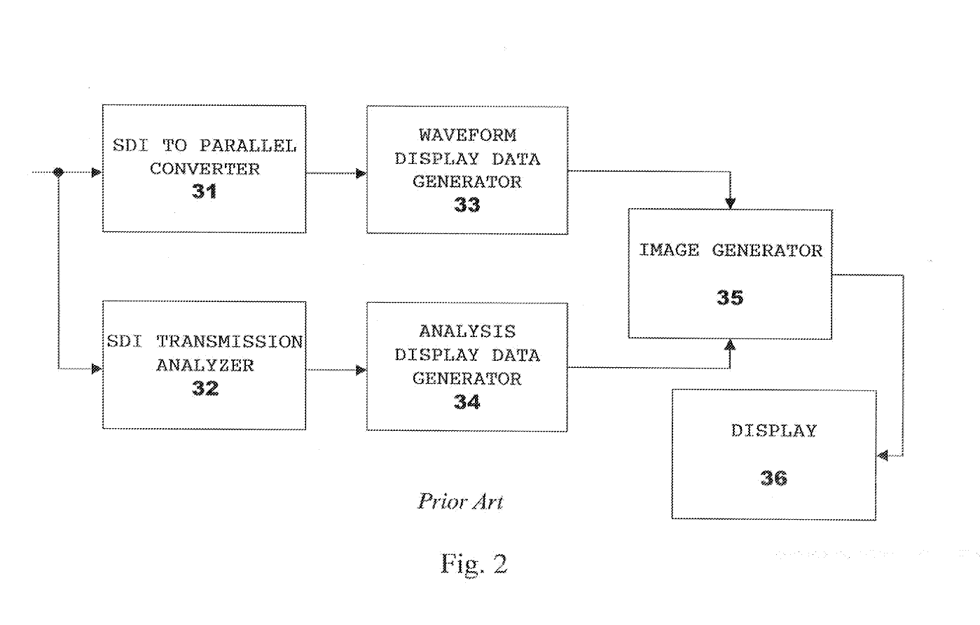

FIG. 3 is a view showing an example of waveform display data, vectorscope display data and video display data, generated by a generator 33 and analysis display data generated by a generator 34;

FIG. 4 is a view for schematically explaining a flow of a video signal, for example, in a broadcasting station, according to the present invention;

FIG. 5 is a schematic functional block diagram of a waveform monitor 41 of the present invention;

FIG. 6 is a view showing an example displayed on a display 36;

FIG. 7 is another schematic functional block diagram of the waveform monitor 41 of the present invention;

FIG. 8 is another functional block diagram of the waveform monitor 41 of the present invention;

FIG. 9 is a view shoving, an example displayed on the display 36;

FIG. 10 is a view showing an example displayed on the display 36; and

FIG. 11 is a view showing an example displayed on the display 36.

### DETAILED DESCRIPTION OF THE INVENTION

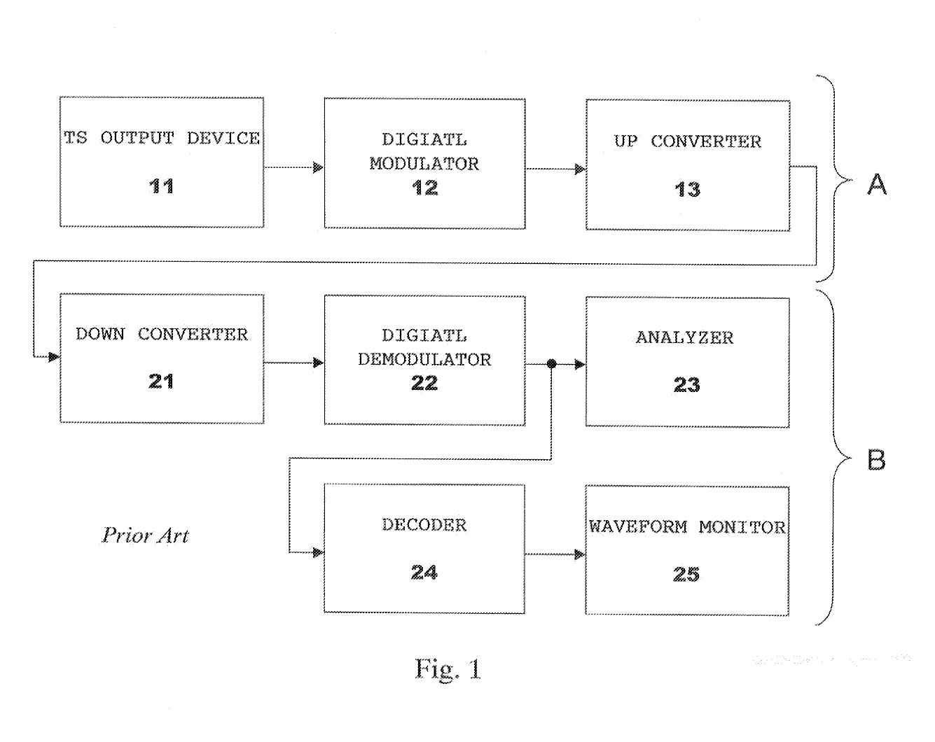

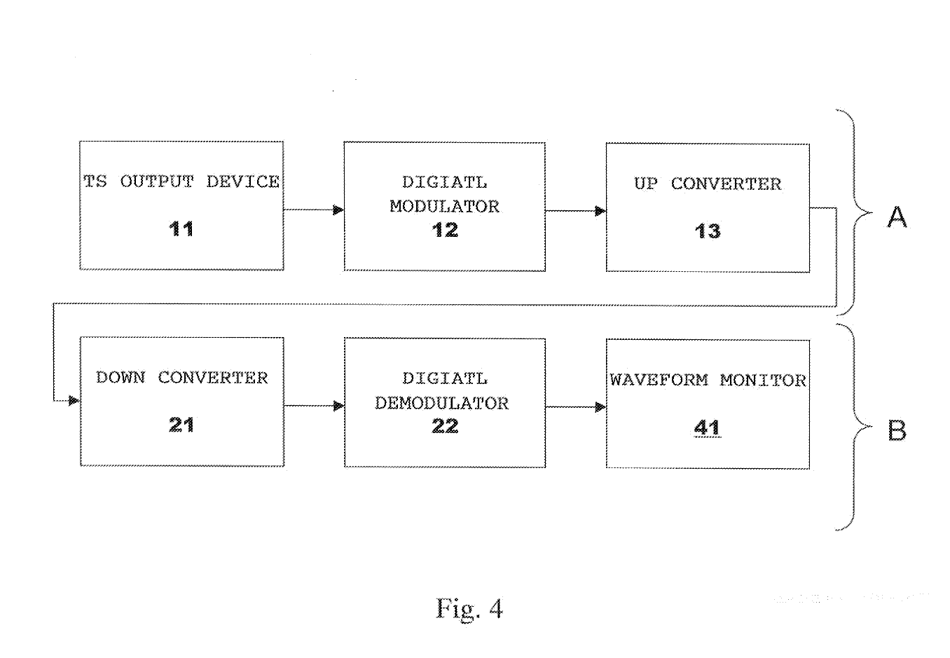

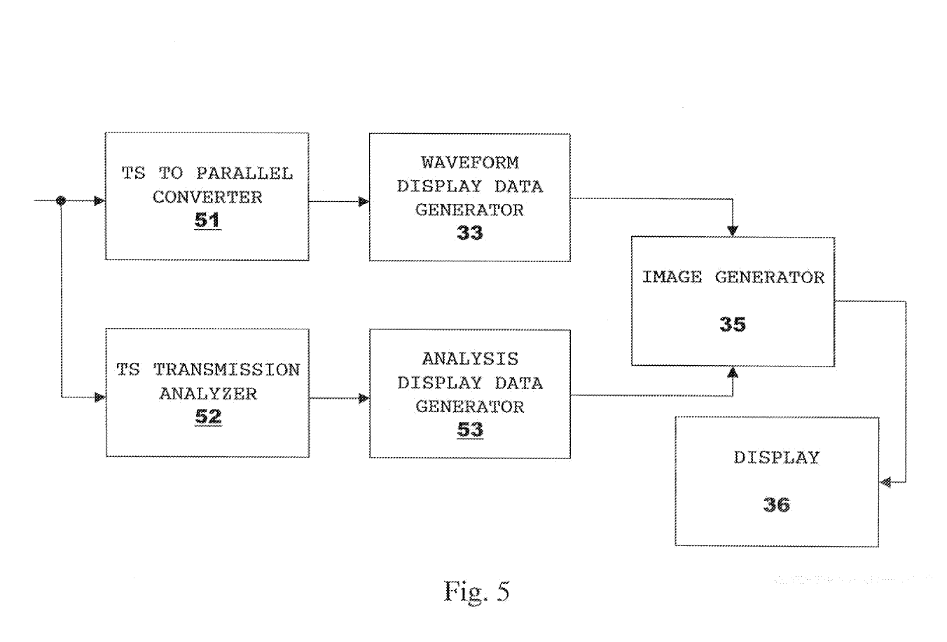

FIG. 4 is a view for schematically explaining a flow of a video signal, for example, in a broad casting station, according to the present invention. A waveform monitor 41 of the present invention is shown in FIG. 4, instead of an analyzer 23, a decoder 24, and a waveform monitor 25 shown in FIG. 1. And, FIG. 5 is a schematic functional block diagram of the waveform monitor 41 of the present invention. Note that a device for outputting a stream may be used instead of a TS output device 11, and in this case, a DV stream signal is transmitted from a broadcasting station A in place of a TS signal. Although a case of the TS signal will be hereinafter described, a signal compressed in another format, such as the DV stream signal, may be used in place of the TS signal.

As shown in FIG. 4, in a broadcasting station B, the TS (transport stream) signal flows from a digital demodulator 22 to the waveform monitor 41. When a plurality of TS signals are decoded in the digital demodulator 22, the waveform monitor can select one TS signal out of the plurality of TS signals.

A converter 51 converts a compressed video signal of the TS signal into parallel data, and a generator 33 converts the parallel data into waveform display data. The generator 33 preferably also converts the parallel data into vectorscope display data and/or video display data. Note that the generator 33 may generate other display data from the parallel data. The generator 33 outputs the display data (for example, a waveform displays a vectorscope display data and a video display data) to an image generator 35. Then the generator 33 outputs a plurality of display data, the generator 33 may combine the plurality of display data.

An analyzer 52 analyzes a transmission status of the compressed video signal of the TS signal, and generates analysis data, and outputs the same to a generator 53. The generator 53 converts (combines) the analysis data into analysis display data, and outputs the same to the image generator 35.

The image generator 35 combines the display data (for example, the waveform display data, the vectorscope display data and the video display data) generated by the generator 33 and the analysis display data generated by the generator 53 to generate one image (frame) data, and outputs it to a display 36. The display 36 displays the one image (frame) data.

Note that when the display 36 displays 60 image (frame) data per second each of the generators 33, 53 and 35 outputs 60 data per second, respectively. Although each of the generators 33, 53 and 35 has been described as a separate functional block, the generators 33, 53 and 35 may be configured as one CPU. Alternatively, each of the generators 33, 53 and 35 may be configured as one CPU, respectively. Further, the converter 51 and the analyzer 52 may be configured as one CPU, together with the generators 33, 53 and 35.

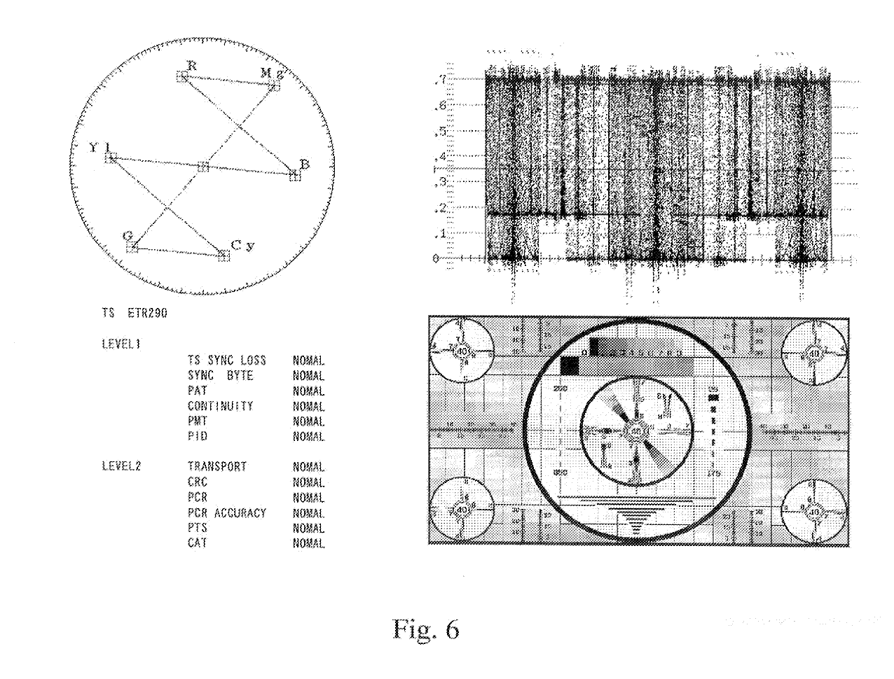

FIG. 6 shows an example displayed on the display 36. As shown in FIG. 6, it is preferable that the waveform display (upper-right), the vectorscope display (upper-left), the video display (lower-right), and analysts result display (lower-left) are displayed simultaneously. But, the waveform display, the vectorscope display, the video display, and the analysis result display are not necessarily displayed simultaneously.

In the example shown in FIG. 6, items analyzed in the analyzer 52 are in levels 1 and 2 of the levels 1 to 3 defined in ETR290 recommended by the ETSI (European Telecommunications Standards Institute). The items analyzed in the analyzer 52 may correspond to the level 3.

More specifically, in the example shown in FIG. 6, “TS SYNC LOSS” in the level 1 means synchronous state of the signal, and “NORMAL” which means that the state is normal, is indicated. Further, “SYNC BYTE” means synchronous information; “PAT” means program association table (designation of table information composing a program); “CONTINUITY” means chronicle continuity of data; “PMT” means program map table (table, information indicating a relationship between a number given to the program and an element of the program, (an image stream, a sound stream, or the like)); and “PID means packet identification (identification number of the stream).

“TRANSPORT” in the level 2 is inform nation existing in the stream and means the presence or absence of an error; “CRC” means a result of integrating analysis results of CAT, PAT, PMT, NIT, EIT, ST and TOT tables, etc. “PCR” means a result of integrating analysis results of parameters of a time interval, a discontinuity, including PCR (program clock reference=time information) jitter, etc.; “PCR ACCURACY” means accuracy of the time information; “PTS” means presentation time stamp (the time information for playing); and “CAT” means conditional access table (management information of the program). When the analysis items in the levels 1 and 2 are not normal, this is indicated (for example, as “ERROR”).

The items analyzed in the analyzer 52 are not limited to the items defined in ETR290, and may be uniquely defined. And, the items analyzed in the analyzer 52 may be at least one of the items defined in ETR290.

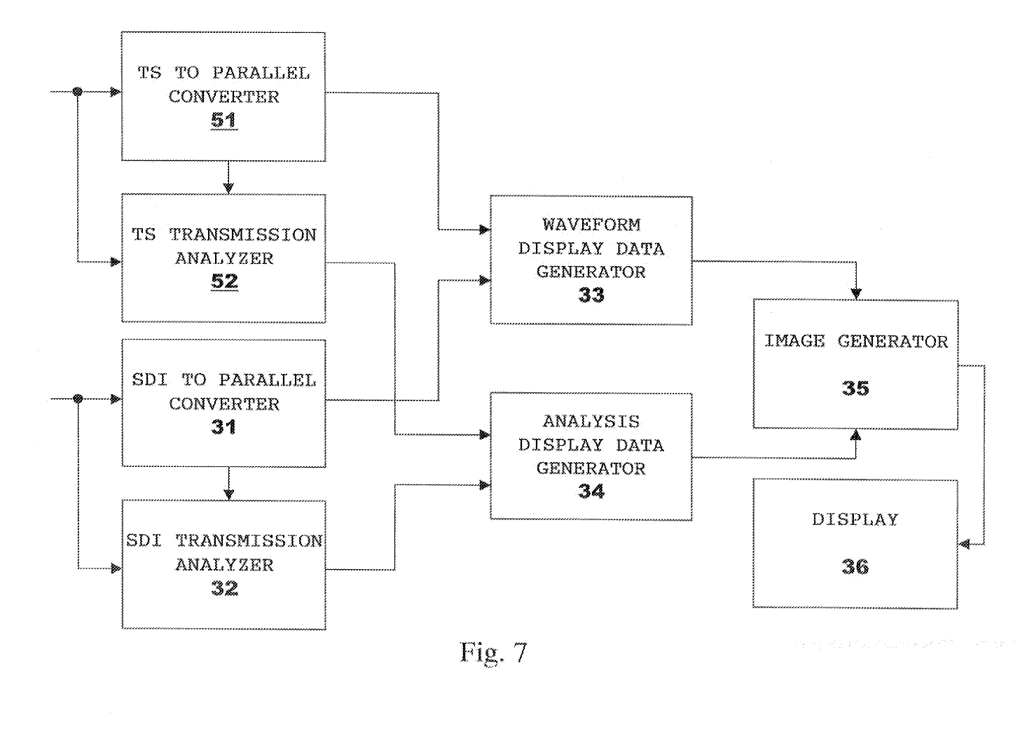

Meanwhile, in the broadcasting station, for example, there exist not only a TS signal but also a SDI signal. Therefore, the waveform monitor 41 preferably processes the SDI signal as in a conventional manner. FIG. 7 is another schematic functional block diagram of the waveform monitor 41 of the present invention. As shown in FIG. 7, the waveform monitor 41 inputs a TS signal at the converter 51 and the analyzer 52, and inputs a SDI signal at the converter 31 and the analyzer 32. Note that operations of the converter 51 and the analyzer 52 are similar to those described with reference to FIG. 5.

The converter 31 converts the SDI signal into parallel data, and outputs the same to the generator 33. When a SDI signal is selected by a user, the generator 33 converts the parallel data from the converter 31 into waveform display data and preferably vectorscope display data and/or video display data), and outputs the same to the image generator 35. When a TS signal is selected by the user, operation of the generator 33 is similar to that described with reference to FIG. 5.

The analyzer 32 analyzes a transmission status of the SDI signal, and generates analysis data, and outputs the same to a generator 34. When the SDI signal is selected by the user, the generator 34 converts (combines) the analysis data from the analyzer 32 to analysis display data, and outputs the same to the image generator 35. When the TS signal is selected by the user, operation of the generator 34 is similar to that of the generator 53 described with reference to FIG. 5.

Operation of the image generator 35 is similar to that of the image generator 35 described with reference to FIG. 5.

Although each of the generators 33, 34 and 35 are described as a separate functional block, respectively, the generators 33, 34 and 35 may be configured as one CPU. Alternatively, each of the generators 33, 34 and 35 may be configured as one CPU, respectively. Further, the converter 51 and the analyzer 52, and, the converter 31 and the analyzer 32, may be configured as one CPU, together with the generators 33, 34 and 35.

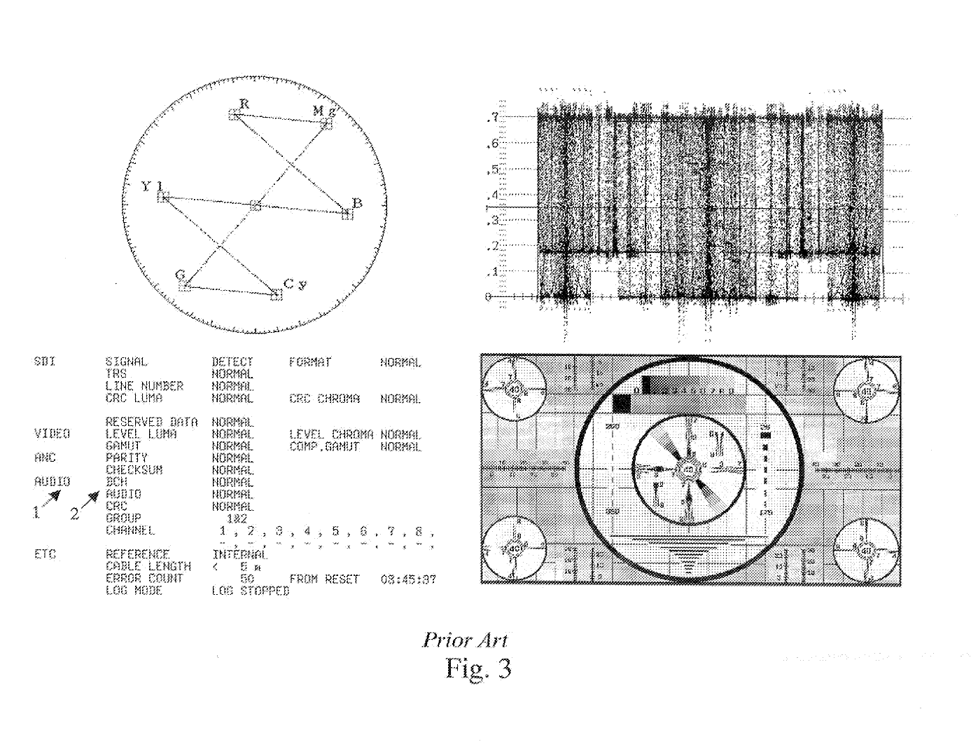

When the SDI signal is selected by the user, it is preferable that the display 36 displays the waveform display (upper-right), the vectorscope display (tipper-left), the video display (lower-right), and the analysis result display (lower-lift) simultaneously as in the case shown in FIG. 3. But, the waveform display, the vectorscope display, the video display, and the analysis result display are not necessarily simultaneously displayed. When the TS signal is selected by the user, the display 36 displays as in the case shown in FIG. 6.

As in the case shown in FIG. 3, the items analyzed in the analyzer 32 include parameters defined in 292M standardized by the Society of Motion Picture and Television Engineers.

As in the case shown in FIG. 3, more specifically, “SIGNAL” of the SDI signal means whether the SDI signal is received or not; and it is indicated (as DETECT) that the SDI signal is received. Further, “FORMAT” means a format of the video signal; “TRS” means timing reference signal (synchronizing signal): “LINE NUMBER” means a number given to scanning lines “CRC LUMA” means a detecting code of a transmission error of a luminance signal; “CRC CHROMA” means a detecting code of the transmission error of a color signal; and “RESERVED DATA” means data existing in a forbidden region.

“VIDEO” means a video signal being transmitted; “LEVEL LUMA” means whether a luminance signal level is within a regulation or not; “LEVEL CHROMA” means whether a color signal level is within a regulation or not; “GUMAT” means a level of the video signal in RGB format; and “COMP GUMAT” means a level of a composite video signal in a case in which the video signal is converted into the composite video signal.

“ANC” means auxiliary data other than video and sound; and each of “PARITY” and “CHECKSUM” means check data of the “ANC”.

“AUDIO” (indicated by an arrow 1 in FIG. 3) means a sound signal being transmitted; “BCH” means the detecting code of the transmission error; “AUDIO” (indicated by an arrow 2 in FIG. 3) means continuity of a sound block; “CRC” means the detecting code of the transmission error; “GROUP” means a selected group of a sound transmission standard; and “CHANNEL” means a total number of channels to which the sound signal is transmitted. In this example, the number of channels is eight.

“ETC” means other information; “REFERENCE” means whether a standard signal in the received signal is used as the standard signal of the waveform monitor (INTERNAL), or a signal externally supplied is used as the standard signal (EXTERNAL); “CABLE LENGTH” means a length of an equivalent cable; TERROR COUNT” means the number of occurrence of error from a predetermined starting time (for example, “08:45:37”) in the above-described detecting items; and “LOG MODE” means that storing of contents of the above-described error is started (LOG STARTED), or the storing thereof is stopped (LOG STOPPED).

The items analyzed in the analyzer 32 are not limited to the items defined in 292M, and may be uniquely defined (for example, the above-described “CABLE LENGTH”). And, the items analyzed in the analyzer 32 may be at least one of the items defined in 292M.

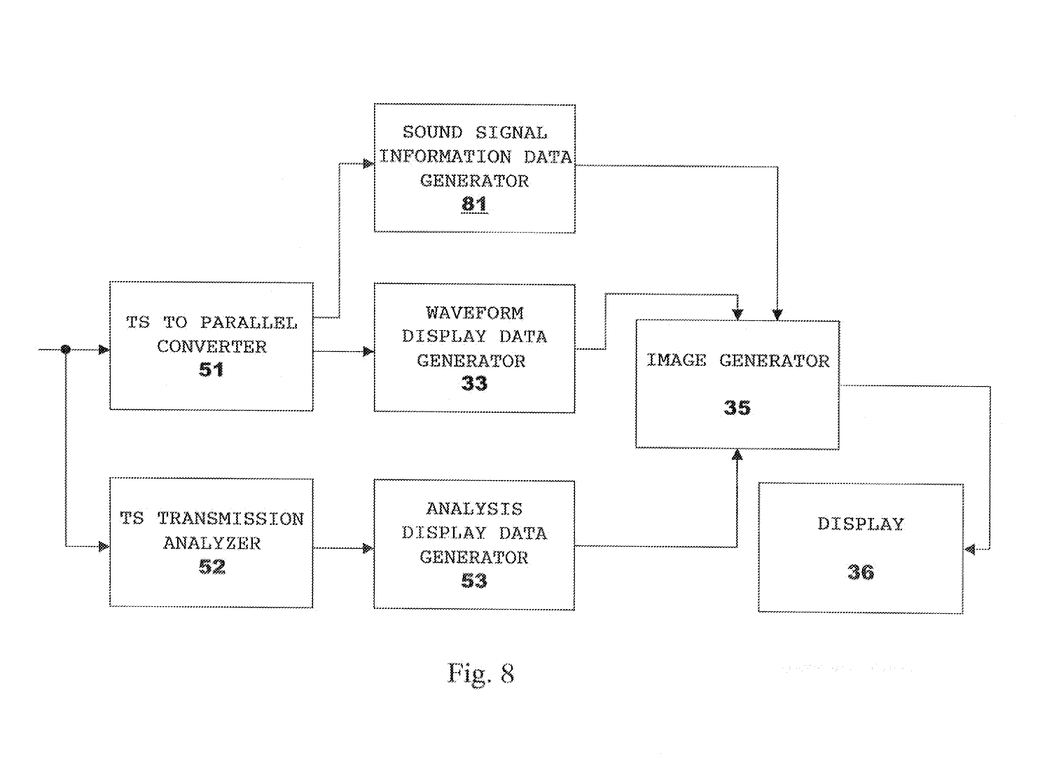

FIG. 8 is another schematic functional block diagram of the waveform monitor 41 of the present invention. Only an operation different from that described with reference to FIG. 5 will be hereinafter described. As compared to FIG. 5, the converter 51 of the waveform monitor 41 shown in FIG. 8 converts a compressed sound signal of the TS signal into second parallel data; and the waveform monitor 41 shown in FIG. 8 further includes means 81 for converting the second parallel data into sound signal information data.

Specifically, the means 81 for converting into the sound signal information data converts the second parallel data into, for example, sound level display data. The means 81 for converting the second parallel data, into the sound signal information data can convert the second parallel data into other sound signal information data (for example, sound-image display data, phase display data between a plurality of sound channels, and phase-waveform display data between the plurality of sound channels. The means 81 for converting the second parallel data into the sound signal information data converts the sound signal information data (for example, the sound level display data and the sound-image display data) into data for displaying and outputs the same to the image generator 35. The image generator 35 combines inputted data to generate one image (frame) data according to a condition $et by the user, and outputs the one image (frame) data to the display 36.

When the waveform display, the vectorscope display, the video display, and the analysis result display are selected by the user, the display 36 displays as in the case shown in FIG. 6.

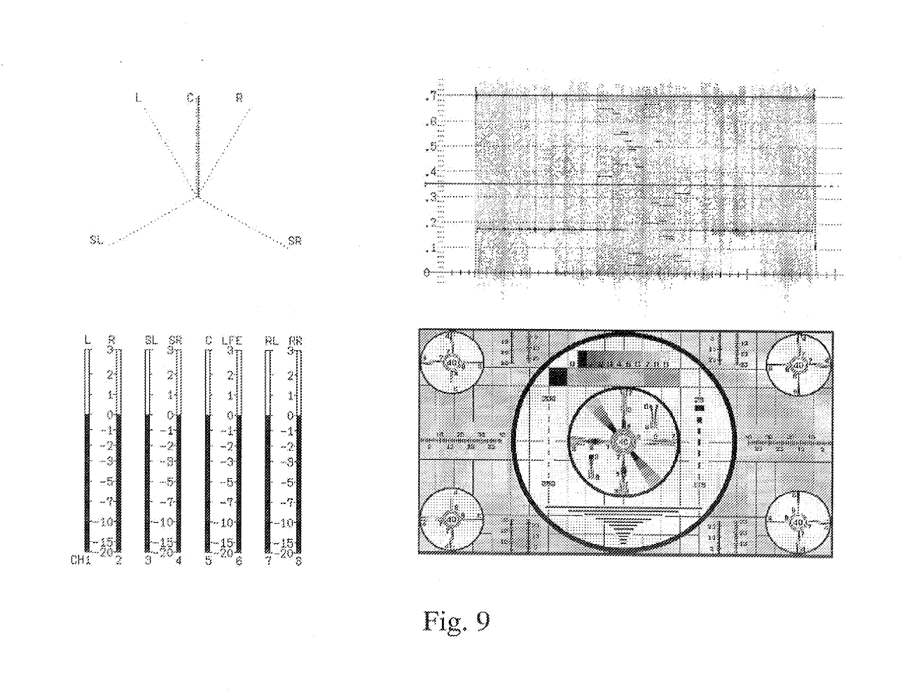

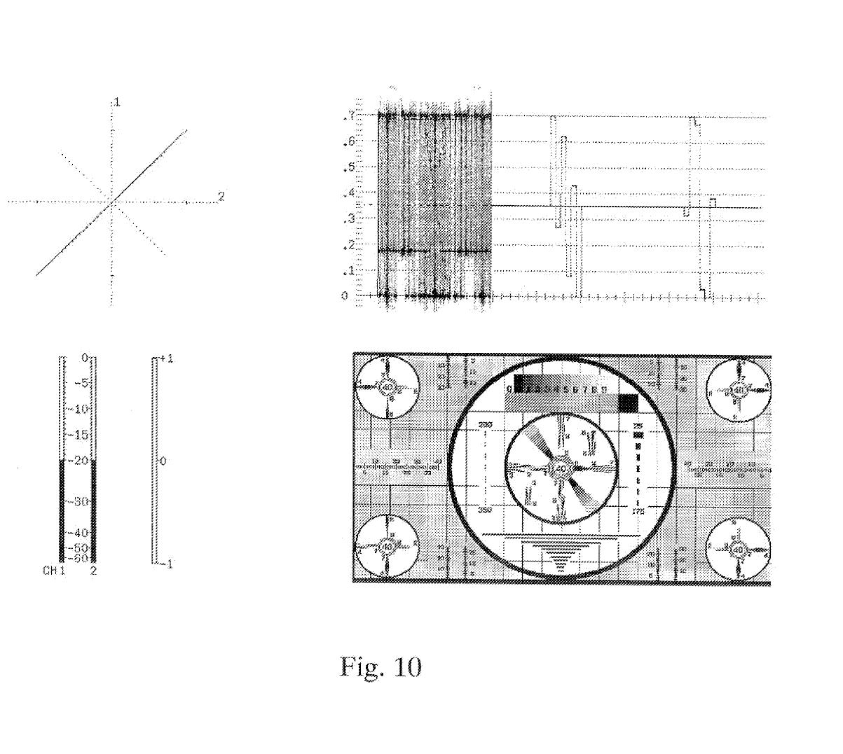

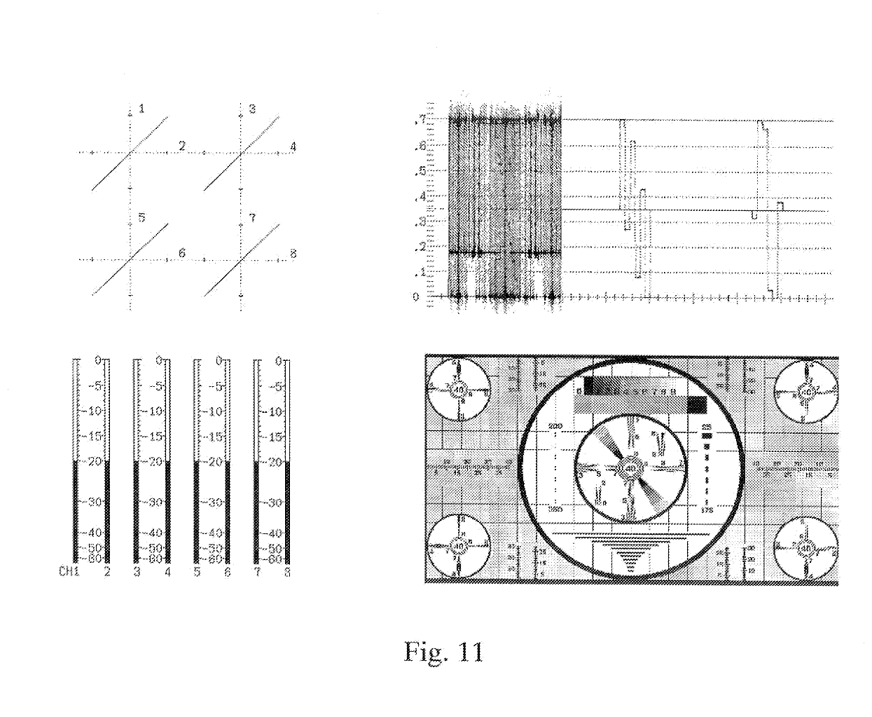

FIGS. 9 to 11 each shows an example displayed on the display 36. When the waveform display, the video display, the sound level display and the sound-image display are selected by the laser, it is preferable that the waveform display (upper-right), the video display (lower-right), the sound level display (lower-left) and the sound-image display (upper-left) are displayed simultaneously as shown in FIG. 9. When the waveform display, the video display, the sound level display, the sound phase display, and the sound phase-waveform display are selected by the user, it is preferable that the waveform display (upper-right), the video display (lower-right), the sound level display and the sound phase display (lower-left) and the sound phase-waveform display (upper-left) are displayed simultaneously as shown in FIG. 10. When the waveform display, the video display, the sound level display, and the sound phase-waveform display are selected by the user, it is preferable that the waveform display (upper-right), the video display (lower-weight), the sound level display (lower-left) and the sound phase-waveform, display (upper-left) are displayed simultaneously as shown in FIG. 11.

Note that the present invention is not limited to the above-described embodiments, and a personal skilled in the art can easily modify the above-described embodiments without departing from the scope of the claims. For example, when the DV stream signal is transmitted from the broadcasting station A instead of the TS signal in FIG. 4, the converter 51 in FIG. 5 converts a compressed video signal of the DV stream signal into parallel data, and the analyzer 52 analyzes a transmission status of the compressed video signal of the DV stream signal. The items analyzed in the analyzer 52 are, for example, items defined in IEEE1394 recommended by the 1394 Trade Association, and the items include “DATA CRC”, which means quality of the transmitted data, etc.

What is claimed is:

1. A waveform monitor comprising:
means (51) for converting a compressed video signal into uncompressed parallel data;
means (33) for converting the parallel data into waveform display data;
means (52) for analyzing a transmission status of the compressed video signal and generating analysis data; and
means (36) for displaying the waveform display data and the analysis data simultaneously.

2. The waveform monitor according to claim 1, further comprising:
means (31) for converting an SDI signal into parallel data; and
means (32) for analyzing a transmission status of the SDI signal and generating the analysis data.

3. The waveform monitor according to claim 2, wherein
the means (33) for converting the parallel data into the waveform display data inputs the uncompressed parallel date from the compressed video signal and the parallel data from the SDI signal,
the meats (33) for converting the parallel data into the waveform display data can select the parallel data from the SDI signal, and
the means (33) for converting the parallel data into the waveform display data converts selected parallel data into the waveform display data.

4. The waveform monitor according to claim 2, wherein
the means (33) for converting the parallel data into the waveform display data inputs the uncompressed parallel data from the compressed video signal and the parallel data from the SDI signal,
the means (33) for converting the parallel data into the waveform display data can select the compressed parallel data from the compressed video signal, and
the means (33) for converting the parallel data into the waveform display data converts selected parallel data into the waveform display data.

5. The waveform monitor according to claim 1, wherein
the means (33) for converting the parallel data into the waveform display data also converts the parallel data into vectorscope display data, and
the means (36) for displaying the waveform display data and the analysis data simultaneously also displays the vectorscope display data.

6. The waveform monitor according to claims 5, wherein
the means (33) for converting the parallel data into the waveform display data and the vectorscope display data also converts the parallel data into video display data, and
the means (36) for displaying the waveform display data, the vectorscope display data and the analysis data simultaneously also displays the video display data.

7. The waveform monitor according to claim 1, wherein
the means (51) for converting the compressed video signal into the uncompressed parallel data converts a compressed sound signal into uncompressed second parallel data, and
the waveform monitor, further comprising:
means (81) for converting the second parallel data into sound signal information data, wherein
the means (36) for displaying the waveform display data and the analysis data simultaneously displays the waveform display data and the sound signal information data simultaneously.

8. The waveform monitor according to claim 1, wherein the compressed video signal is a video signal compressed in TS signal format or DS stream format.
